(19) United States
(12) Patent Application Publication
(10) Pub. No.: US 2014/0375590 A1
(43) Pub. Date: Dec. 25, 2014

(54) MULTI-RESOLUTION MICRO-WIRE TOUCH-SENSING METHOD

(71) Applicant: Ronald Steven Cok, Rochester, NY (US)

(72) Inventor: Ronald Steven Cok, Rochester, NY (US)

(21) Appl. No.: 13/921,261

(22) Filed: Jun. 19, 2013

(51) Int. Cl. G06F 3/044

(52) U.S. Cl. CPC G06F 3/044
USPC 345/174

(57) ABSTRACT

A method for touch sensing in a touch-screen device includes providing an array of independently controlled and electrically separate drive electrodes, an array of independently controlled and electrically separate sense electrodes, wherein the drive electrodes and the sense electrodes define touch locations in a touch-detection area. The method further includes providing a touch-detection circuit having a separate connection to each of the drive electrodes and a separate connection to each of the sense electrodes for detecting touches at a touch location in the touch-detection area. The touch-detection circuit controls three or more electrodes at the same time to detect a single sense signal responsive to the controlled three or more electrodes, the three or more electrodes including at least one drive electrode and at least one sense electrode. A processor analyzes the single sense signal and determines a touch at a touch location.

### CROSS REFERENCE TO RELATED APPLICATIONS

Reference is made to commonly assigned, co-pending U.S. Patent Application (K001541) filed concurrently herewith entitled “Multi-Resolution Micro-Wire Touch-Sensing Device” by Ronald S. Cok, the disclosure of which is incorporated herein.

### FIELD OF THE INVENTION

The present invention relates to touch screens having a matrix-addressed control method.

### BACKGROUND OF THE INVENTION

Touch screens use a variety of technologies, including resistive, inductive, capacitive, acoustic, piezoelectric, and optical technologies. Such technologies and their application in combination with displays to provide interactive control of a processor and software programs are well known in the art. Capacitive touch-screens are of at least two different types: self-capacitive and mutual-capacitive. Self-capacitive touch-screens employ an array of transparent electrodes, each of which in combination with a touching device (e.g. a finger or conductive stylus) forms a temporary capacitor whose capacitance is detected. Mutual-capacitive touch-screens can employ an array of transparent electrode pairs that form capacitors whose capacitance is affected by a conductive touching device. In either case, each capacitor in the array is tested to detect a touch and the physical location of the touch-detecting electrode in the touch-screen corresponds to the location of the touch. For example, U.S. Pat. No. 7,663,607 discloses a multipoint touch-screen having a transparent capacitive sense medium configured to detect multiple touches or near touches that occur at the same time and at distinct locations in the plane of the touch panel and to produce distinct signals representative of the location of the touches on the plane of the touch panel for each of the multiple touches. The disclosure teaches both self- and mutual-capacitive touch-screens.

Referring to FIG. 17, a capacitive touch-screen device found in the prior-art includes a substrate 10. Substrate 10 is typically a dielectric material such as glass or plastic with two opposing flat and parallel sides. An array of drive electrodes 30 is formed on one side of substrate 10 and an array of sense electrodes 20 is formed on the other opposing side of substrate 10. The drive electrodes 30 extend in a drive electrode direction 32 and the sense electrodes 20 extend in a sense electrode direction 22. The extent of the drive electrodes 30 and the sense electrodes 20 define a touch-detection area 70. Each location at which a drive electrode 30 and a sense electrode 20 overlap forms a capacitor defining a touch location 60 at which a touch is detected; for example the touch location 60 is shown in FIG. 17 as a projection from the substrate 10 where a drive electrode 30 and a sense electrode 20 overlap. Thus, the touch locations 60 form a two-dimensional array corresponding to the locations at which the drive electrodes 30 and the sense electrodes 20 overlap in touch-detection area 70. A cover (not shown in FIG. 17) is located over the substrate 10 to protect the sense and drive electrodes 20, 30.

Each of the drive electrodes 30 is connected by a wire 50 to a drive-electrode circuit 44 in a touch-screen controller 40. Likewise, each of the sense electrodes 20 is separately connected by a wire 50 to a sense-electrode circuit 42 in the touch-screen controller 40. Under the control of a control circuit 46, the drive-electrode circuit 44 provides current to the drive electrodes 30, producing an electrical field.

Under the control of the control circuit 46, the sense-electrode circuit 42 detects the capacitance of the electrical field at each sense electrode 20, for example by measuring the electrical field capacitance. In typical capacitive touch-screen devices, each drive electrode 30 is stimulated in turn and, while each drive electrode 30 is stimulated, the capacitance at each sense electrode 20 is separately measured, thus providing a measure of the capacitance at each touch location 60 where a drive electrode 30 overlaps a sense electrode 20. Thus, the capacitance is detected at each touch location 60 in the array of touch locations 60. The capacitance at each touch location 60 is measured periodically, for example ten times, one hundred times, or one thousand times per second. Changes or differences in the measured capacitance at a touch location 60 indicate the presence of a touch, for example by a finger, at that touch location 60.

A variety of calibration and control techniques for capacitive touch screens are taught in the prior art. U.S. Patent Application Publication No. 2011/0248955 discloses a touch detection method and circuit for capacitive touch panels. The touch detection method for capacitive touch panels includes scanning the rows and columns of the capacitive matrix of a touch panel respectively, wherein during the scanning of the rows or columns of the capacitive matrix of the touch panel, two rows or columns are synchronously scanned at the same time to obtain the capacitance differential value between the two rows or columns, or one row or column is scanned at the same time to obtain the capacitance differential value between the row or column and a reference capacitance; and then processing the obtained capacitance differential value.

U.S. Patent Application Publication No. 2010/0244859 teaches a capacitance measuring system including analog-digital calibration circuitry that subtracts baseline capacitance measurements from touch-induced capacitance measurements to produce capacitance change values.

U.S. Pat. No. 8,040,142 discloses touch detection techniques for capacitive touch sense systems that include measuring a capacitance value of a capacitance sensor within a capacitance sense interface to produce a measured capacitance value. The measured capacitance value is analyzed to determine a baseline capacitance value for the capacitance sensor. The baseline capacitance value is updated based at least in part upon a weighted moving average of the measured capacitance value. The measured capacitance value is analyzed to determine whether the capacitance sensor was activated during a startup phase and to adjust the baseline capacitance value in response to determining that the capacitance sensor was activated during the startup phase.

U.S. Patent Application Publication No. 2012/0043976 teaches a technique for recognizing and rejecting false activation events related to a capacitance sense interface that includes measuring a capacitance value of a capacitance sense element. The measured capacitance value is analyzed to determine a baseline capacitance value for the capacitance sensor. The capacitance sense interface monitors a rate of change of the measured capacitance values and rejects an activation of the capacitance sense element as a non-touch event when the rate of change of the measured capacitance values have a magnitude greater than a threshold value, indicative of a maximum rate of change of a touch event.

Touch-screens, including very fine patterns of conductive elements, such as metal wires or conductive traces are known. For example, U.S. Patent Publication No. 2011/0007011 teaches a capacitive touch screen with a mesh electrode, as does U.S. Patent Publication No. 2010/0026664. U.S. Patent Application Publication No. 2011/0291966 discloses an array of diamond-shaped micro-wire structures.

Although a variety of capacitive touch-sensing devices are known, there remains a need for further improvements in sensing frequency and sensitivity.

### SUMMARY OF THE INVENTION

In accordance with the present invention, a method for touch sensing in a touch-screen device comprises:

providing an array of independently controlled and electrically separate drive electrodes, an array of independently controlled and electrically separate sense electrodes, wherein the drive electrodes and the sense electrodes define touch locations in a touch-detection area;

providing a touch-detection circuit having a separate connection to each of the drive electrodes and a separate connection to each of the sense electrodes for detecting touches at a touch location in the touch-detection area;

using the touch-detection circuit to control three or more electrodes at the same time to detect a single sense signal responsive to the controlled three or more electrodes, the three or more electrodes including at least one drive electrode and at least one sense electrode; and

using a processor to analyze the single sense signal and determine a touch at a touch location.

The present invention provides a device and method for touch sensing in a matrix-addressed touch screen device. The touch screen device has improved response frequency and sensitivity.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIGS. 1 and 2 are schematic block diagrams of various embodiments of the present invention;

FIG. 3 is a detail schematic block diagram of a component illustrated in FIG. 2;

FIG. 4 is a schematic diagram of a circuit useful in various embodiments of the present invention;

FIGS. 5 and 6 are schematic block diagrams of circuit elements illustrated in FIG. 4;

FIGS. 7A-7C are numeric listings of values useful in controlling electrodes of the present invention;

FIGS. 8A-8C are block diagrams illustrating electrode control corresponding to the numeric listing of FIG. 7C;

FIG. 9A is a numeric listing illustrating electrode control signals useful in various embodiments of the present invention;

FIGS. 9B-9D are block diagrams illustrating electrode control signals corresponding to FIG. 9A;

FIG. 10A is a block diagram illustrating a touch useful in understanding various embodiments of the present invention;

FIGS. 10B-10D are numeric listings and block diagrams illustrating electrode control signals corresponding to FIG. 10A useful in various embodiments of the present invention;

FIG. 11 A is an illustration of control bits useful in various embodiments of the present invention;

FIG. 11B is a numeric listing illustrating electrode control signals corresponding to FIGS. 10B-10D and FIG. 11A;

FIGS. 12-16 are flow diagrams illustrating various embodiments of the present invention; and

FIG. 17 is an illustration of a prior-art capacitive touch screen device.

### DETAILED DESCRIPTION OF THE INVENTION

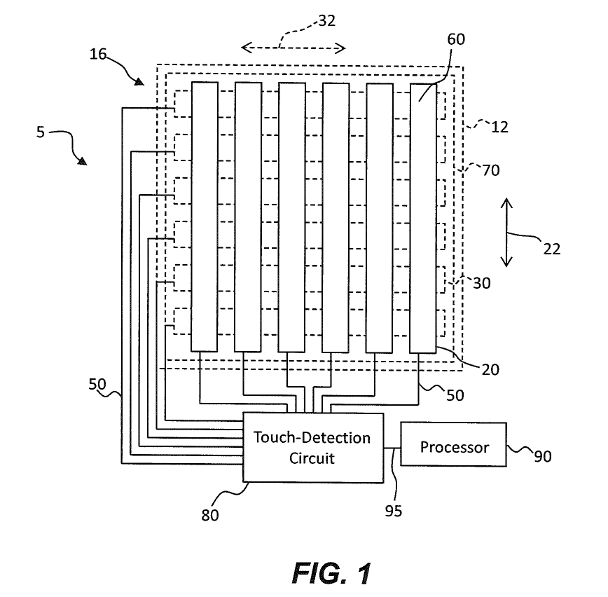

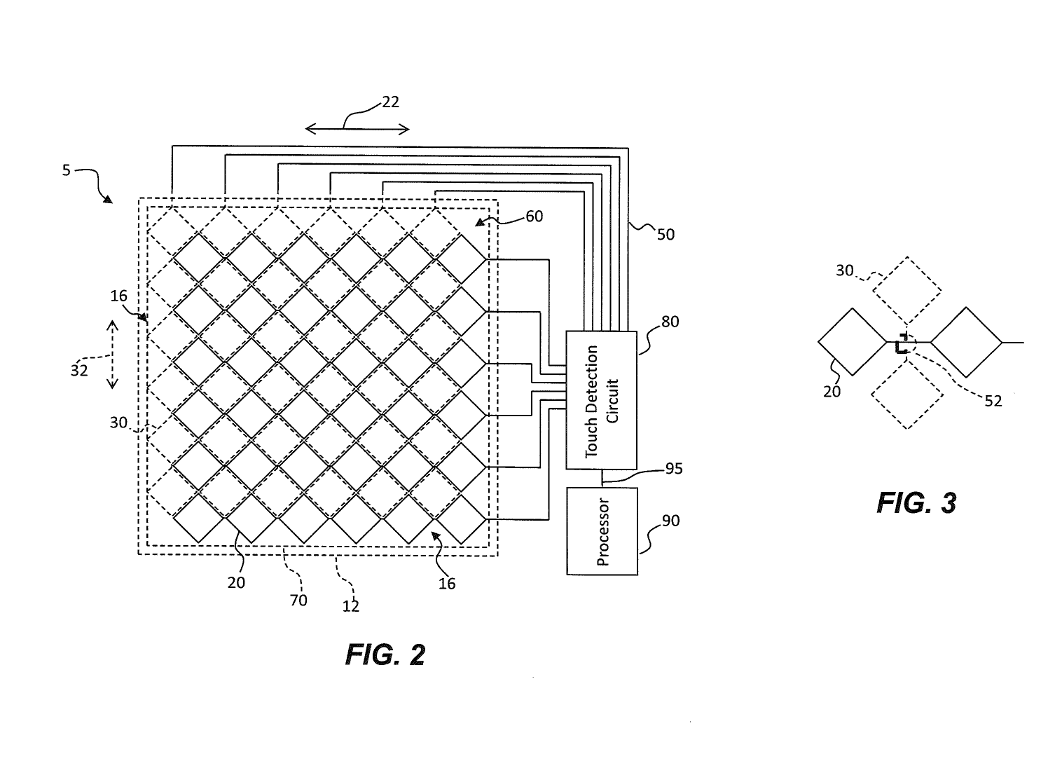

The present invention provides a device and method for sensing touches in a touch screen controlled through matrix-addressed electrodes. Referring to FIGS. 1 and 2, a touch screen device 5 according to various embodiments of the present invention includes a surface 12 having a touch-detection area 70. A plurality of electrodes 16 includes a first array of independently controlled and electrically separate drive electrodes 30 and a second array of independently controlled and electrically separate sense electrodes 20. The first array of drive electrodes 30 and second array of sense electrodes 20 define touch locations 60 in the touch-detection area 70.

A touch-detection circuit 80 has a separate connection to each of the drive electrodes 30 and a separate connection to each of the sense electrodes 20 to detect touches at the touch locations 60 in the touch-detection area 70. The touch-detection circuit 80 controls three or more electrodes 16 at the same time to detect a single sense signal 95 responsive to the controlled three or more electrodes 16. The three or more electrodes 16 include at least one drive electrode 30 and at least one sense electrode 20. A processor 90 analyzes the single sense signal 95 and determines a touch at the touch location 60.

As used herein, to control an electrode 16 is to either drive the electrode 16 with a signal by providing a circuit that electrically stimulates the electrode 16 with a signal or to sense a signal on the electrode 16 by providing a circuit that is responsive to any signal present on the electrode 16. A detected single sense signal 95 is a single measurement or sensing of a signal present on one or more sense electrodes 20. The magnitude of the measurement corresponds to the presence, absence, or proximity of a touch in association with the one or more sense electrodes 20. A detected single sense signal 95 is also a sensed single sense signal 95 or a measured single sense signal 95. An electrode group includes the electrodes 16 that are controlled at the same time to detect a single sense signal 95 responsive to the controlled electrodes 16

In an embodiment, the drive electrodes 30 extend across the touch-detection area 70 in a drive-electrode direction 32. The sense electrodes 20 extend across the touch-detection area 70 in a sense-electrode direction 22.

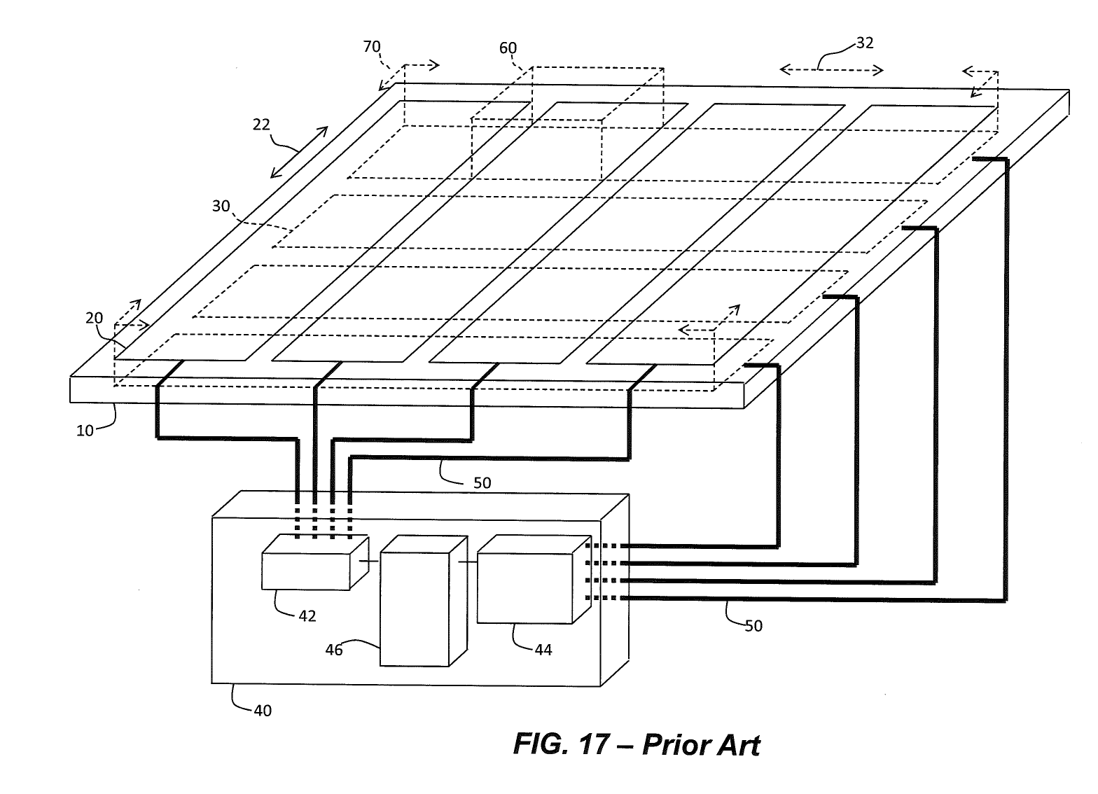

According to the embodiment illustrated in FIG. 1, the drive electrodes 30 and the sense electrodes 20 are formed in separate and parallel planes, for example on opposite sides of the substrate 10 (FIG. 17). The drive-electrode direction 32 and the sense-electrode direction 22 are different, for example orthogonal, so that the drive electrodes 30 overlap the sense electrodes 20 to form an array of capacitors. Each capacitor forms a touch location 60. By energizing the drive electrodes 30 and sensing the sense electrodes 20, a touch at a touch location 60 can be determined.

According to the embodiment illustrated in FIG. 2, the drive electrodes 30 and the sense electrodes 20 are formed in a common plane. As shown in FIG. 3, a via 52 maintains electrical isolation between overlapping portions of the drive electrodes 30 and the sense electrodes 20. The formation of vias 52 in a multi-layer electrode structure is known in the printed circuit board arts. In the design of FIG. 2, capacitors are formed between adjacent portions of the drive electrodes 30 and the sense electrodes 20. Each capacitor forms a touch location 60. By energizing the drive electrodes 30 and sensing the sense electrodes 20, a touch at a touch location 60 can be determined. Electronic circuits for driving electrodes and sensing signals, for example capacitive signals, are known in the electronic arts.

As shown in FIGS. 1 and 2, the touch-detection circuit 80 has a separate connection to each of the drive electrodes 30 and a separate connection to each of the sense electrodes 20 for detecting touches at touch locations 60 in the touch-detection area 70. The separate connection, for example a wire 50, is an electrical connection that is electrically isolated from the electrical connections of the other drive or sense electrodes 30, 20, except as described further below. Electronic circuits for driving electrodes 16 and detecting or sensing signals, for example capacitive signals, are known in the electronic arts. Although a capacitive embodiment of the present invention is described herein and has been constructed and tested, other embodiments, for example resistive or optical can employ methods and devices of the present invention.

According to other embodiments of the present invention, other arrangements of electrodes 16 on a surface 12 forming a touch-detection area 70 are employed and other detection, sensing, or measurement methods are used. The present invention is not limited by the arrangements of electrodes 16 or the touch detection modality employed by the touch-detection circuit 80. Furthermore, the use of the terms “drive” and “sense” do not limit the control or detection methods or devices used in the present invention. As is appreciated by those skilled in the electronic arts, the drive and sense electrodes 30, 20 or their control circuits can be exchanged and working devices and methods according to various embodiments of the present invention obtained.

In various embodiments, the substrate 10 can include glass or plastic and electrodes 16 are formed from transparent conductive oxides such as ITO or from interconnecting micro-wires, as is known in the display and touch screen arts. The deposition and patterning of the electrodes 16 on the substrate 10 is also widely known. Interconnections for the wires 50 on the substrate 10 and the touch-detection circuitry 80 can include ribbon cables soldered or otherwise electrically connected to the substrate 10 or to integrated circuits on printed circuit boards. In some embodiments of the present invention, the touch-detection circuit 80 and processor 90 are made from integrated circuits or other electrical devices.

The touch-detection circuit 80 and the processor 90 can be made in a common electrical device and are not necessarily distinguished. Such circuits can be made from digital computing logic elements, integrated circuits, programmable logic, gate arrays, or other computational elements that are well known in the art. The circuits can be formed in a single integrated circuit, in multiple circuits, or integrated on one or more printed circuit boards, wafers, or modules.

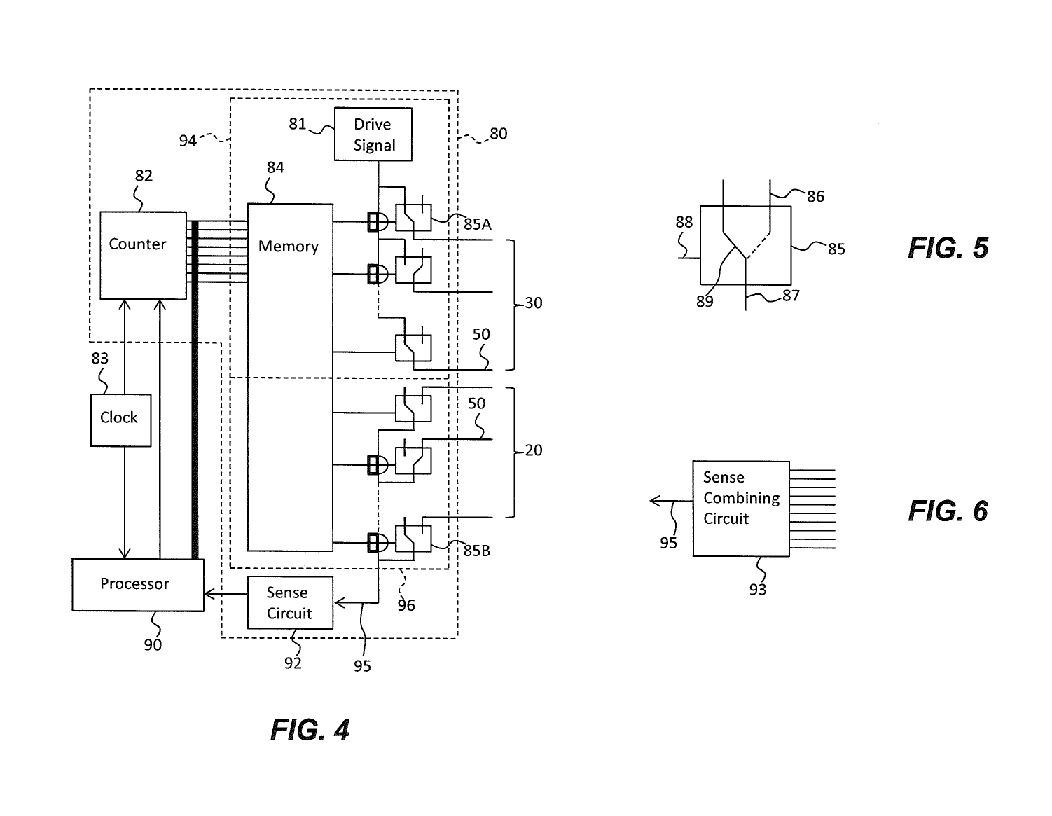

Referring in more detail to FIG. 4, the touch-detection circuit 80 can include a counter 82 driven by a clock 83. The counter 82 produces a binary value that serves as an address to a memory 84. The address provided to the memory 84 is also controlled by the processor 90. The memory 84 has a plurality of values stored therein, for example stored by the processor 90, that are output corresponding to the address provided, for example by the counter 82. Each binary bit of the value stored in the memory 84 serves as a control signal for a corresponding drive electrode 30 or as a control signal for a corresponding sense electrode 20. In the embodiment of FIG. 4, the control signals are provided to control drive-signal analog switches 85A for each drive electrode 30 or sense-signal analog switches 85B for each sense electrode 20, or both.

A drive-signal circuit 81 provides a drive signal to the input of a drive-signal analog switch 85A for each drive electrode 30. Depending on the value of the control signal bits output by the memory 84 in response to the applied address signal, one or more of the drive signals is then applied to the drive electrodes 30 through the wires 50. Thus, the memory 84, the drive-signal circuit 81, and the drive-signal analog switches 85A provide a drive-control circuit 94 that has a value input specifying the two or more drive electrodes 30, a common drive signal input, and a separate output connected to each drive electrode 30.

Similarly, depending on the value of the control signal bits output by the memory 84 in response to the applied address signal, one or more of the sense signals from the sense electrodes 20 through wires 50 and sense-signal analog switches 85B forms a single sense signal 95 that is applied to a sense circuit 92. The memory 84 can be a single memory or multiple memories with separate controls, as will be appreciated by knowledgeable logic circuit designers.

Thus, the memory 84 and the sense-signal analog switches 85B provide a sense-control circuit 96 that has a value input specifying the two or more sense electrodes 20, a sense-combining circuit input, and a combined single sense signal output 95.

An analog switch 85 corresponding to drive-signal analog switches 85A and sense-signal analog switches 85B is shown in further detail in FIG. 5. The analog switch 85 includes two analog-switch inputs 86 and an analog-switch output 87. Either of the two analog-switch inputs 86 is electrically connected to the analog-switch output 87 by an analog-switch element 89 depending on the logical state of an analog switch control 88. The analog-switch element 89 is illustrated with a solid line to the analog-switch input 86 to which the analog-switch output 87 is connected and a dotted line the analog-switch input 86 to which the analog-switch output 87 is not connected. If an analog-switch input is unconnected, it is typically pulled to a ground state. Such analog switches are known in the art and can include field effect transistors, operational amplifiers, or analog computer circuits known in the art.

As shown in FIG. 4, all of the sense signals from the sense electrodes 20 that are switched through sense-analog switches 85B to the sense circuit 92 are electrically connected in common, forming the single sense signal 95. The single sense signal 95 is then measured with a single measurement by the sense circuit 92. Thus, referring also to FIG. 6, a sense-combining circuit 93 includes a sense-signal analog switch 85B for each sense electrode 20. Each sense-signal analog switch 85B has an analog-switch sense-electrode input, an analog switch control input, and an analog switch sense output connected in common with the sense output of each of the analog switches 85B.

In an alternative embodiment, the value of each sense electrode 20 that is switched through by sense-signal analog switches 85B is separately provided to a sense-combining circuit 93. The sense-combining circuit 93 then combines the signals to provide the single sense signal 95. In this embodiment, the sense-combining circuit 93 includes a sample circuit for each sense electrode 20 for storing a sampled value and a combining circuit for reading the sampled values corresponding to the value input, for example using operational amplifiers.

However, only a single measurement is made of the single sense signal 95 and therefore of the controlled sense electrodes 20, thereby providing a more efficient and rapid way to sense any signal on the sense electrodes 20, since an individual measurement of any signal on each sense electrode 20 is not needed.

The single sense signal 95 is illustrated in FIGS. 4 and 6 as a wire or electrical connection but, as will be appreciated by those skilled in circuit design, can represent the signal or information carried by the wire or electrical connection.

The circuit design illustrated in FIG. 4 is only one design suitable for the present invention and the present invention is not limited by this exemplary illustration. Skilled circuit designers will readily understand and appreciate that alternative circuits can implement the control, drive, and sensing circuitry needed for the present invention.

According to embodiments of the present invention, the touch-detection circuit 80 controls three or more electrodes 16 at the same time to sense a single sense signal 95 responsive to the controlled three or more electrodes 16. The three or more electrodes 16 include at least one drive electrode 30 and at least one sense electrode 20. At the same time means simultaneously and vice versa. There are at least two embodiments, which can be combined, to use three electrodes 16.

In a first embodiment, two or more drive electrodes 30 are simultaneously controlled to provide identical, common drive signals to two or more separate drive electrodes 30 while one or more sense signals are sensed to provide the single sense signal 95, at the same time.

In a second embodiment, one or more drive electrodes 30 are simultaneously controlled to provide identical common drive signals to one or more separate drive electrodes 30 while at the same time sense signals from two or more sense electrodes 20 are simultaneously combined to provide a single sense signal 95.

In a third embodiment, two or more drive electrodes 30 are simultaneously controlled to provide identical common drive signals to two or more separate drive electrodes 30 and at the same time two or more sense signals from two or more sense electrodes 20 are simultaneously combined to provide a single sense signal 95.

The two or more drive electrodes 30 can be adjacent, or not, as can the sense electrodes 20. Adjacent drive electrodes 30 are a set of drive electrodes 30 that are not separated by any drive electrode 30 that is not a member of the set. Similarly, adjacent sense electrodes 20 are a set of sense electrodes 20 that are not separated by any sense electrode 20 that is not a member of the set.

The single sense signal 95 is responsive to the three or more electrodes 16. Thus, in the first embodiment, the single sense signal 95 is sensed by at least one sense electrode 20 whose sensed value corresponds to the drive signal provided by at least two drive electrodes 30. Thus, the single sense signal 95 is responsive to at least two drive electrodes 30 and at least one sense electrode 20. In the second embodiment, the single sense signal 95 is sensed by at least two sense electrodes 20 whose sensed value corresponds to the drive signal provided by at least one drive electrode 30. Thus, the single sense signal 95 is responsive to at least one drive electrode 30 and at least two sense electrodes 20. In the third embodiment, the single sense signal 95 is sensed at the same time by at least two sense electrodes 20 whose sensed value responds to the identical common drive signal provided by at least two drive electrodes 30. Thus, the single sense signal 95 is responsive to at least two drive electrodes 30 and at least two sense electrodes 20.

In contrast to the present invention, sensing methods of the prior art drive only a single drive electrode 30 at a time. Each sensed signal from sense electrodes 20, even if measured at the same time, is measured as a separate sense signal. Thus, measured sense signals of the prior art are responsive to only two electrodes 16 at a time, in contrast to the three electrodes 16 required by the present invention. If, according to an embodiment of the present invention, one sense electrode 20 senses a signal provided by two drive electrodes 30, the single sense signal 95 is responsive to the two drive electrodes 30 providing the drive signal and is responsive to the one sense electrode 20 sensing the signal, so that the single sense signal 95 is responsive to three electrodes 16. If, according to another embodiment of the present invention, two sense electrodes 20 sense a signal provided by one drive electrode 30, the single sense signal 95 is responsive to the one drive electrode 30 providing the drive signal and is responsive to the two sense electrodes 20 that both sense the signal together and whose sensed signal is combined to form a single sense signal 95, so that the single sense signal 95 is responsive to three electrodes 16. Thus, according to embodiments of the present invention, when signals are present on two or more sense electrodes 20, only one signal is detected or measured to make the single sense signal 95. In contrast, prior art methods detect or measure a signal from each sense electrode 20.

By employing at least three electrodes at a time to provide a single sense signal, the present invention provides a mechanism to increase the sensitivity of the touch detection and to increase the frequency at which electrodes 16 can be tested to detect touches. Because at least two electrodes 16 are either driven simultaneously or sensed together to form a single sense signal 95, the area over the substrate 10 that is affected by a physical touch on the substrate 10 is increased, for example doubled. This increase in affected area corresponds to an increase in the affected capacitive area thereby increasing the signal from the touch.

In an experiment, two orthogonal arrays of micro-wire electrodes 16 were formed on opposite sides of a transparent polymer substrate. As a control test, a single drive electrode 30 was driven with a drive signal and a response sensed by a single sense electrode 20, as is commonly practiced in the prior art. An uncalibrated capacitance signal with a value of 31 was detected in the presence of a physical finger touch. In an inventive experimental test, two adjacent drive electrodes 30 were driven with a common drive signal at the same time and a response sensed by two adjacent sense electrodes 20 at the same time, according to one embodiment of the present invention. An uncalibrated capacitance signal with a value of 127 was detected in the presence of a physical finger touch. The second value of 127 is approximately four times as large as the first value of 31, as would be expected from measuring the capacitance over an area four times as large (formed by the overlap of two drive electrodes 30 with two sense electrodes 20).

The present invention can, but need not necessarily, increase the frequency with which arrays of drive electrodes 30 and sense electrodes 20 are tested for touches. Since more than one drive electrode 30 or sense electrode 20 is controlled or sensed together at the same time, fewer times are needed to control or sense the drive electrodes 30 and sense electrodes 20. For example, if two drive electrodes 30 are driven at the same time with the same drive signal, it will take half as many drive signals to drive the drive electrodes 30. Similarly, if two sense electrodes 20 are sensed together at the same time with a common sense signal, it will take half as many sense signals to sense the sense electrodes 20. Thus, assuming one time period to sense each sense electrode 20 in response to each drive electrode 30, the experiment described above will require only one quarter as many time periods to control and sense the drive and sense electrodes 30, 20. Thus, the touch locations 60 in the touch-detection area 70 can be tested at four times the rate, increasing responsiveness in a touch screen according to the present invention. Alternatively, one quarter of the tests are performed, reducing energy use according to the present invention.

Although the detection frequency of touches is increased or energy use decreased according to embodiments of the present invention, the location specificity is reduced when three or more electrodes 16 are used to detect a touch. Since the touch location 60 is determined, at least in part by the maximum sensed signal, and the sensed signal corresponds spatially to the locations of the drive and sense electrodes 30, 20 providing the single sensed signal 95, multiple drive and sense electrodes 30, 20 form a larger capacitive area in which the sensed touch occurs, resulting in a larger sensed signal over a larger, less specific, area.

Since it is useful to specify the location of a touch to as small an area as possible, in a further embodiment of the present invention, the touch-detection circuit 80 is used to separately and sequentially control one or more drive electrodes 30 with a drive signal. For each controlled one or more drive electrodes 30, the touch-detection circuit 80 is used to separately sense a single sense signal 95 for one or more sense electrodes 20. The processor 90 is used to analyze the single sense signals 95 and determine a touch, thereby performing a high-resolution scan of an area to determine a high-resolution touch at a touch location 60 within a high-resolution touch area defined by the controlled one or more drive electrodes 30 and sensed one or more sense electrodes 20. A scan of a touch area includes driving the drive electrodes 30 and sensing the sense electrodes 20 defining the touch area. The drive electrodes 30 and sense electrodes 20 can be driven individually or in groups of electrodes. Thus, if all of the drive electrodes 30 and sense electrodes 20 are in a single group and controlled at the same time, the touch area corresponding to the drive electrodes 30 and sense electrodes 20 is scanned in a single step. If the drive electrodes 30 and sense electrodes 20 are each controlled individually, the touch area corresponding to the drive electrodes 30 and sense electrodes 20 is scanned in a number of steps corresponding to the product of the number of drive electrodes 30 and the number of sense electrodes 20.

Each touch location 60 formed by each possible combination of drive electrode 30 and sense electrode 20 can be tested. However, not every touch location 60 needs to be tested. For example, by first using three or more electrodes 16 to first detect a touch at a high frequency and increased sensitivity, the location of the touch corresponds to the used three or more electrodes 16 is discovered. In a second step, the touch is further located by individually driving and sensing combinations of only the three or more electrodes 16 in electrode groups used in the first step that indicated a touch. Even if multiple touches are detected in the first step, each of the detected multiple touch locations is separately tested in the second step.

Therefore, according to an embodiment of the present invention, with a first set of control signals the touch-detection circuit 80 controls two or more drive electrodes 30 at the same time with a common drive signal or senses two or more sense electrodes 20 at the same time to form a single sense signal 95 responsive to three or more electrodes 16. With a second set of control signals touch-detection circuit 80 controls only one drive electrode 30 and senses only one sense electrode 20 form a single sense signal 95 responsive to only two electrodes 16. With a third set of control signals the touch-detection circuit 80 controls two or more drive electrodes 30 at the same time with a common drive signal and senses two or more sense electrodes 20 at the same time to form a single sense signal 95 responsive to four or more electrodes 16. The first, second, and third sets of control signals can be stored as values in memory 84 and applied to the electrodes 16 at different times.

The two-step detection process can be faster than a single complete high-resolution scan of the touch-detection area 70. For example, using a first detection step with electrode groups including two drive electrodes 30 and two sense electrodes 20 in a 32-by-32 array of drive and sense electrodes 30, 20 requires 256 tests. The second test detection step requires only four tests using the electrodes 16 of the electrode group for which a touch was determined, for a total of 260 tests. If a single, high-resolution scan were employed to individually test each combination of drive and sense electrodes 30, 20, 1,024 tests are required. Thus, the present invention provides a faster touch detection method with greater sensitivity than is found in the prior art. Alternatively, a two-step process can be employed by first using electrode groups of four drive electrodes 30 and four sense electrodes 20 64 times, then testing the 16 combinations of four drive electrodes 30 and four sense electrodes 20, for a total of 80 tests.

In a further embodiment of the present invention, a multi-step process with more than two steps is used, for example three steps. In such an embodiment, a set of eight drive electrodes 30 and eight sense electrodes 20 are used 16 times to reduce the number of touch locations 60 to 64 possibilities. In a second step, a set of four drive electrodes 30 and four sense electrodes 20 are used four times using the electrodes 16 in the electrode group covering the area in which the touch was detected in the first step to reduce the number of touch locations 60 to 16 possibilities. In a last step, each drive electrode 30 and each sense electrode 20 are used sixteen times using the electrodes 16 in the electrode group covering the area in which the touch was detected in the second step to reduce the number of touch locations 60 to one possibility. Thus, a total of 36 tests are made to locate the touch location 60, rather than individually testing each of 1024 possible touch locations 60. In further embodiments, the number of steps is the log base 2 of the number of drive electrodes 30 or sense electrodes 20 and at each test the number of drive electrodes 30 or sense electrodes 20 used in the electrode groups is reduced by a factor of two. For example, in the case of a 32-by-32 array of drive and sense electrodes 30, 20, in a first step, four electrode groups each including sixteen of each of the drive and sense electrodes 30, 20 are each used one time to reduce the number of locations to 256. In a second step, electrode groups including eight of each of the drive and sense electrodes 30, 20 in the area in which a touch was detected in the first step are each used one time to reduce the number of touch locations 60 to 64. In a third step, electrode groups including four of each of the drive and sense electrodes 30, 20 in the area in which a touch was detected in the second step are each used one time to reduce the number of touch locations 60 to 16. In a fourth step, electrode groups of two of each of the drive and sense electrodes 30, 20 in the area in which a touch was detected in the third step are each used one time to reduce the number of locations to four. In a fifth and final step, each of the drive and sense electrodes 30, 20 in the area in which a touch was detected in the fourth step are used to reduce the number of locations to one.

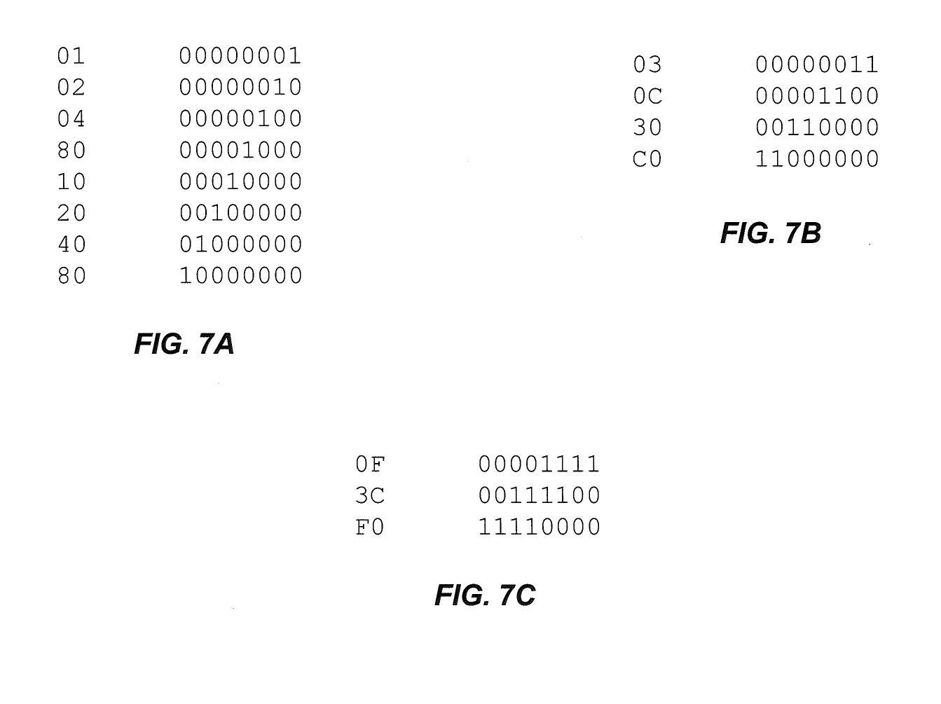

Referring to FIGS. 7A-7C, various implementations of various embodiments of the present invention are described. In each of these Figures, the left-side column is a hexadecimal representation of a value stored at subsequent addresses of the memory 84 and the right-side column is the binary equivalent of the same value. As illustrated in FIG. 4, as the counter 82 responsive to the clock 83 counts, the values stored in the memory 84 are sequentially applied to the output of the memory 84 and to the analog switch controls 88 of drive-signal analog switches 85A to control the drive signals applied to the drive electrodes 30. As shown in FIG. 7A, each value is double the previous value so that each analog switch 85A in turn is turned on, thus applying a drive signal to each drive electrode 30 in turn. This set of memory values thus controls one drive electrode 30 at a time. Therefore, for an 8-bit system, eight drive electrodes are controlled in 8 periods.

In an embodiment of the present invention and as illustrated in FIG. 7B, each memory value has two bits turned on, so that two drive-signal analog switches 85A are turned on at a time, thus applying a common drive signal to two drive electrodes 30 at a time. In the 8-bit system illustrated in FIG. 7B, only four periods are needed to control the eight drive electrodes 30. In this arrangement, the eight drive electrodes 30 are included in four groups, with no drive electrode 30 included in more than one group. The four groups are activated in turn as the counter 82 increments.

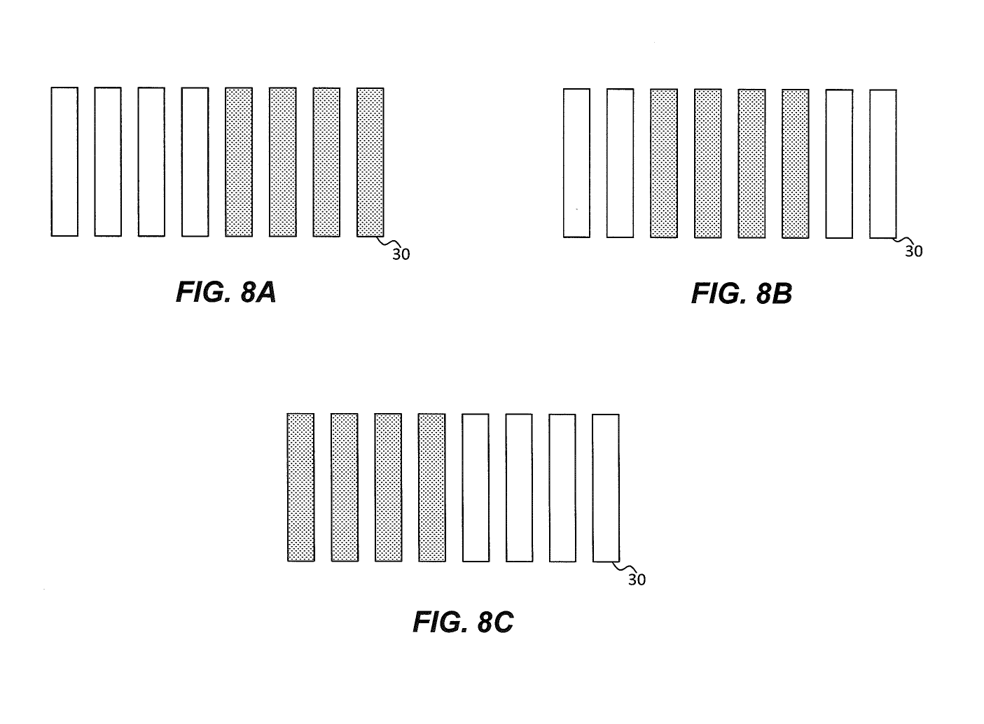

Referring to FIG. 7C, three electrode groups include four drive electrodes 30 each. In this arrangement, drive electrodes 30 are included in more than one group. The three groups are activated in turn as described above. FIGS. 8A, 8B, and 8C illustrate the array of drive electrodes 30 that are activated by the control bits of FIG. 7C. In this illustration, activated drive electrodes 30 are shown as shaded; non-activated drive electrodes 30 are not shaded.

Although not illustrated in FIGS. 7A-7C, the sense electrodes 20 can be controlled in similar fashion to produce a single sense signal 95 for each electrode group. Each single sense signal 95 is then tested by processor 90 to determine if any of the single sense signals 95 indicates a touch.

Therefore, in an embodiment of the present invention, the electrodes 16 are associated into electrode groups. At least one electrode group has three or more electrodes 16 including at least one drive electrode 30 and at least one sense electrode 20. The touch-detection circuit 80 separately and sequentially controls each electrode group. Controlling each electrode group includes controlling the three or more electrodes 16 in the electrode group at the same time to sense a single sense signal 95 responsive to the controlled three or more electrodes 16. For each electrode group, a separate single sense signal 95 is obtained. The sense circuit 92 can measure the detected single sense signal 95. The processor analyzes the measured single sense signal 95 of each electrode group to determine a touch, thereby performing a low-resolution scan of the touch-detection area 70 to determine a low-resolution touch at a touch location 60 within a low-resolution touch area defined by the controlled drive electrodes 30 and controlled sense electrodes 20.

As illustrated in FIGS. 4 and 7A-7C, the electrode groups are defined by values stored in the storage elements (memory locations) of the memory 84. The values stored in the storage element (memory 84) define the drive electrodes 30 in each electrode group and the sense electrodes 20 in each electrode group. In the design of FIG. 4, the bits corresponding to the stored values are applied to drive-signal and sense-signal analog switches (85A, 85B) to control the drive and sense electrodes 30, 20. Thus, the counter 82 references a memory address whose value in turn specifies the electrode group.

The memory 84 can store values specifying a first set of electrode groups and a second set of electrode groups, for example drive electrodes 30 or sense electrodes 20, or electrode groups that are modified over time or that are modified in response to a sensed touch. The first set of electrode groups can include more electrodes 16 than the second set of electrode groups, for example if a scan of the electrodes 16 is followed by a scan of only a portion of the electrodes 16. The second set of electrode groups can be defined by a touch location 60 sensed in the first set of electrode groups, for example if a touch is detected in a low-resolution scan and a second, high-resolution scan of only the area in which the touch was detected is subsequently performed. The first set of electrodes 16 can include all of the electrodes 16 and the second set of electrode groups can include fewer than all of the electrodes 16. In another embodiment, a storage element such as memory 84 can store a third set of electrode groups or more sets of electrode groups. To scan an area that is a portion of the touch-detection area 70 is to control the electrodes 16 detecting touches in the area to detect a touch in the area.

In various embodiments of the present invention, no sense electrode 20 is included in more than one electrode group, no drive electrode 30 is included in more than one electrode group, at least one sense electrode 20 is included in more than one group, at least one drive electrode 30 is included in more than one group, the electrode groups include all of the sense electrodes 20 and all of the drive electrodes 30, or the electrode groups include fewer than all of the sense electrodes 20 or fewer than all of the drive electrodes 30. By applying suitable values to the memory 84, the various embodiments of the present invention are implemented. For example a memory value of FF in hexadecimal notation will turn on every one of eight drive electrodes 30 or sense electrodes 20 when applied to the analog-switch control 88 of analog switches 85 corresponding to the drive electrodes 30 or sense electrodes 20.

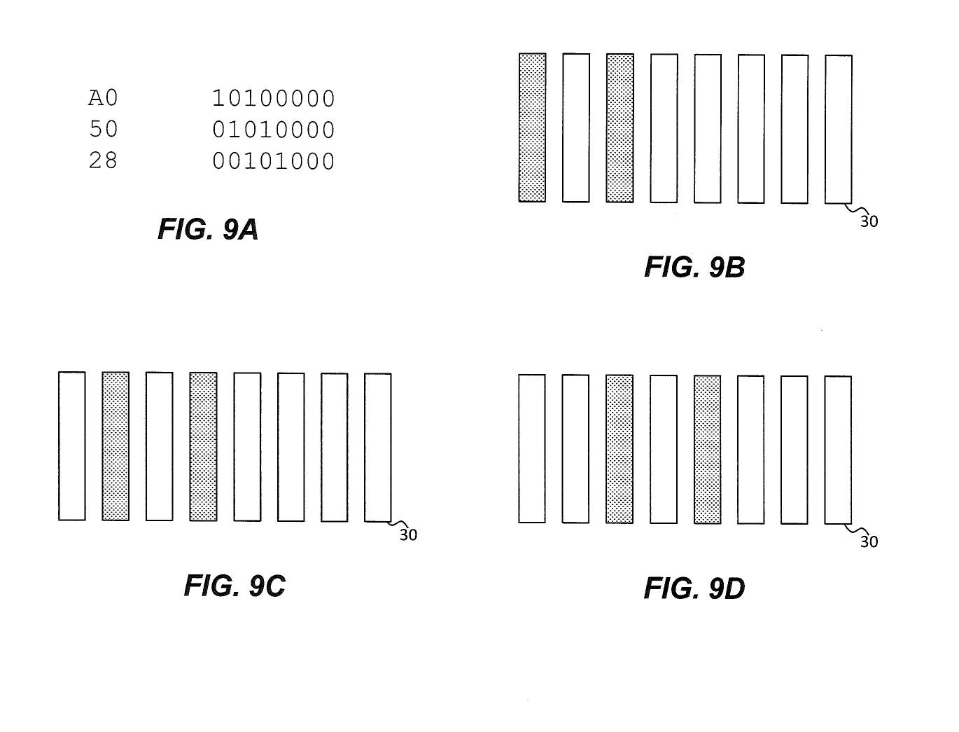

FIGS. 7B, 7C, and 8A-8C illustrate activated drive electrodes 30 that are adjacent. By adjacent activated drive electrodes 30 is meant that no non-activated drive electrode 30 (or sense electrode 20) is between any two activated drive electrodes 30 (or sense electrodes 20). In a further embodiment of the present invention illustrated in FIGS. 9A-9D, activated drive electrodes 30 (or sense electrodes 20, not shown) are not adjacent. FIG. 9A illustrates the memory values corresponding to the analog switch controls for the drive-signal analog switches 85A. FIGS. 9B, 9C, and 9D illustrate the array of drive electrodes 30 that are activated by the control bits of FIG. 9A. In these illustrations, activated drive electrodes 30 are shown as shaded, non-activated drive electrodes 30 are not shaded. Again, such embodiments can be implemented by applying suitable values to the memory 84, as illustrated in FIG. 9A.

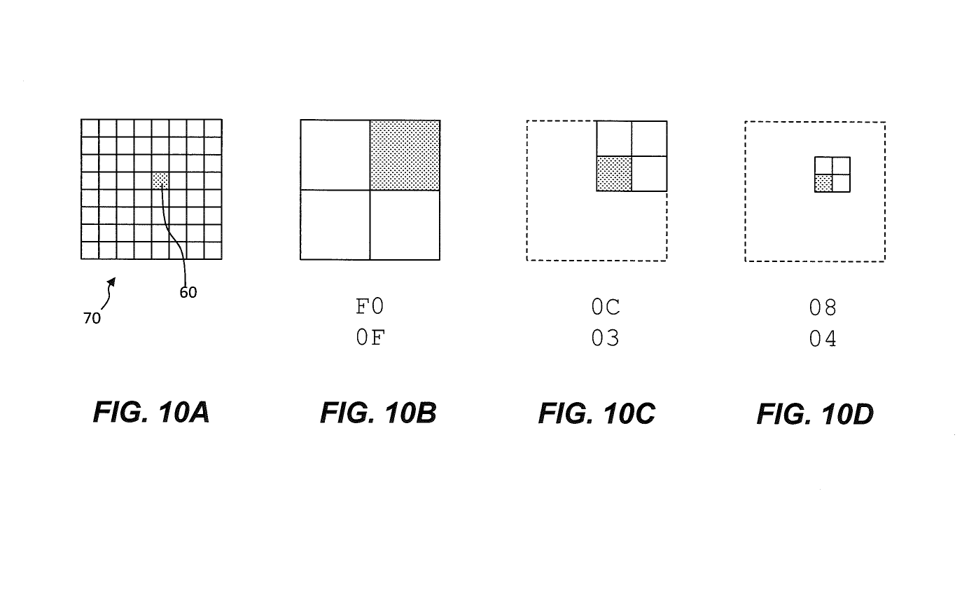

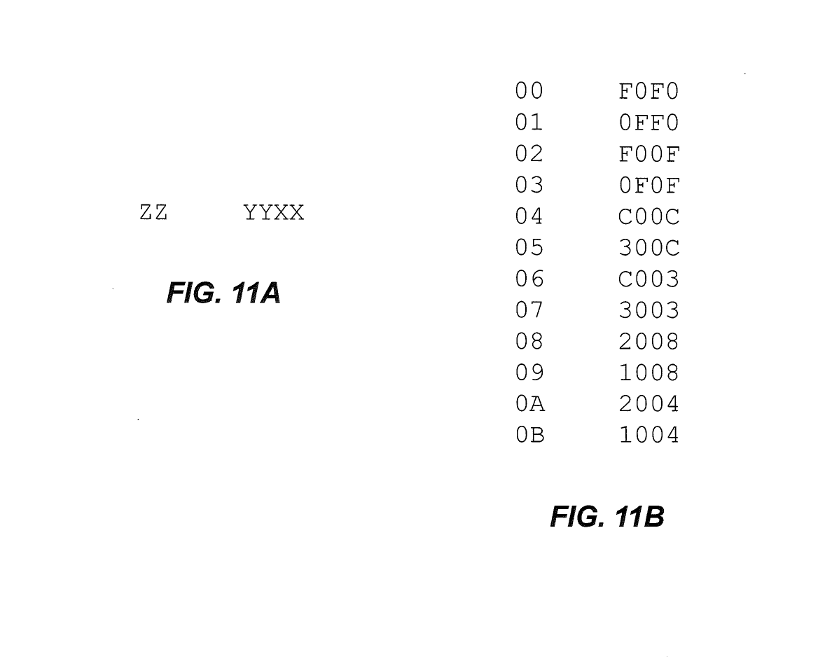

A multi-resolution, multi-step example useful with the present invention is described with reference to FIGS. 10A-10D and FIGS. 11A and 11B. As illustrated in FIG. 1 OA, the touch-detection area 70 includes an eight-by-eight array of touch locations 60, one of which is shaded to represent a touch at that location. Referring to FIG. 10B, a drive-control signal provides control bits represented by vertically sequential hexadecimal values for drive electrodes 30. The hexadecimal values control vertical drive electrodes 30 with the highest bit corresponding to the left-most drive electrode 30 and the lowest bit corresponding to the right-most drive electrode 30. In a first step illustrated in FIG. 10B, value 0F first controls four drive electrodes 30 to sense a touch in the left side of the touch-detection area 70 corresponding to the first four drive electrodes 30. Value OF then controls the other four drive electrodes 30 to sense a touch in the right side of the touch-detection area 70 corresponding to the last four drive electrodes 30. As indicated in FIG. 10A, the indicated touch location 60 is in the right half of the touch-detection area 70.

In a second step illustrated in FIG. 10C, value OC first controls two drive electrodes 30 to sense a touch in the left side of the right half of the touch-detection area 70 corresponding to two drive electrodes 30. Value 03 then controls the other two drive electrodes 30 to sense a touch in the right half of the right side of the touch-detection area 70 corresponding to the last two drive electrodes 30. As indicated in FIG. 10A, the indicated touch location 60 is in the left side of the right half of the touch-detection area 70.

In a third step illustrated in FIG. 10D, value 08 first controls one drive electrode 30 to sense a touch in the indicated area corresponding to the drive electrode 30. Value 04 then controls the other drive electrode 30 to sense a touch in the indicated area corresponding to the drive electrode 30, as shown.

FIGS. 10B-10D only describe controlling the vertical drive electrodes 30, providing an indication of a touch location in the horizontal direction. Referring to FIG. 11A, memory values in the memory 84 can store control bits for both the drive electrodes 30 and the sense electrodes 20. As shown, drive-control signals are illustrated as bits ‘X’ and sense-control signals are illustrated as bits ‘Y’. The address of the memory location storing the ‘X’ and ‘Y’ values is indicated with ‘Z’.

Using the bit structure specified in FIG. 11A and referring to FIG. 11B, a complete cycle of testing the touch-detection area 70 of FIG. 10A with both drive signals and sense signals is illustrated. In FIG. 11B, the hexadecimal memory address on the left corresponds to the hexadecimal bit control pattern on the right and simply serves to provide a sequential series of bit-control patterns as counter 82 counts. In this arrangement, the upper bits of the sense-control bits are applied to the upper rows of touch locations 60.

Thus, in a first step, control pattern FOFO tests the upper-left quadrant of touch locations 60 (address 00), followed by the lower-left quadrant (address 01). Then the upper-right quadrant of touch locations 60 are tested (address 02), followed by the lower-right quadrant (address 03). Since the only touch location 60 indicated is in the upper-right quadrant, control values in address locations 04-07 are programmed into the memory 84, for example by the processor 90, to subsequently test only the upper-right quadrant of touch locations 60.

In a second step, control pattern 0C0C tests the upper-left portion of the upper-right quadrant of touch locations 60 (address 04) followed by the lower-left portion of the upper-right quadrant (address 05). Then the upper-right portion of the upper-right quadrant of touch locations 60 are tested (address 06) followed by the lower-right portion of the upper-right quadrant (address 07). Since the only touch location 60 indicated is in the lower-left portion of the upper-right quadrant, control values in address locations 08-0B are programmed into memory 84, for example by the processor 90, to test only the lower-left portion of the upper-right quadrant of touch locations 60.

In a third step, in the lower-left portion of the upper right quadrant of touch locations 60, control pattern 0808 tests the upper-left touch location 60 (address 08), followed by the lower-left portion (address 09), the upper-right touch location 60 (address 0A), followed by the lower-right portion (address 07). The touch location 60 at address 09 having control bits 1008 locates the touch in twelve test cycles.

For an embodiment in which the detection of only one touch is desired, it is possible to further reduce number of test cycles by abandoning further tests once a touch is detected, for example by programming a new value into the counter 82 so that only some of the electrode groups are used to control the electrodes 16. The reduction in test cycles will depend on the location of the touch with respect to the order in which the touch locations 60 are tested. In the example of FIGS. 10A-10D and FIG. 11A-11B, if this strategy was employed, 7 tests would have been needed. If a touch was located in the upper left touch location 60, three tests would be required. If a touch was located in the lower right touch location 60, twelve tests would be required.

For an embodiment in which the detection of multiple touches is desired, further test cycles are needed to test each area in which a touch is detected. For example, if a touch was located in the upper right quadrant (as shown in FIG. 10A) and another touch located in the lower left quadrant (not shown), the process illustrated in FIGS. 10C and 10D would be needed for both upper right and lower left quadrants. If two touches were located in the upper right quadrant, the process illustrated in FIG. 10C would be needed for only the upper right quadrants, but the process of FIG. 10D, depending on the location of the two touches, can be repeated twice. Thus, the present invention is applicable to both single-touch and multi-touch devices with savings of time and improvements in sensitivity realized depending on the locations of the touches in a touch-detection area 70.

In yet another embodiment of the present invention, all the electrode groups are tested regardless of touches detected earlier. For example, using the electrode groups illustrated in FIGS. 10A-10D and 11A-11B, in a first step the four quadrants are tested, as shown in address 00-03 of FIG. 11B. In a second step, however, all of the touch locations 60 in each quadrant are tested, rather than in only the quadrant in which a touch was detected. This embodiment is useful when no touch is detected most of the time. Thus, the four quadrants are repeatedly tested at a very high frequency and low resolution (since there are only four quadrants), until a touch is detected. Then a high-resolution test is conducted to locate the touch more specifically. Even if fewer electrodes 16 are in the low-resolution electrode groups so that more than four low-resolution areas are tested (for example testing using 16, 32, or 64 electrode groups), substantial improvements in the frequency of touch tests are realized, in addition to the added sensitivity of the low-resolution tests.

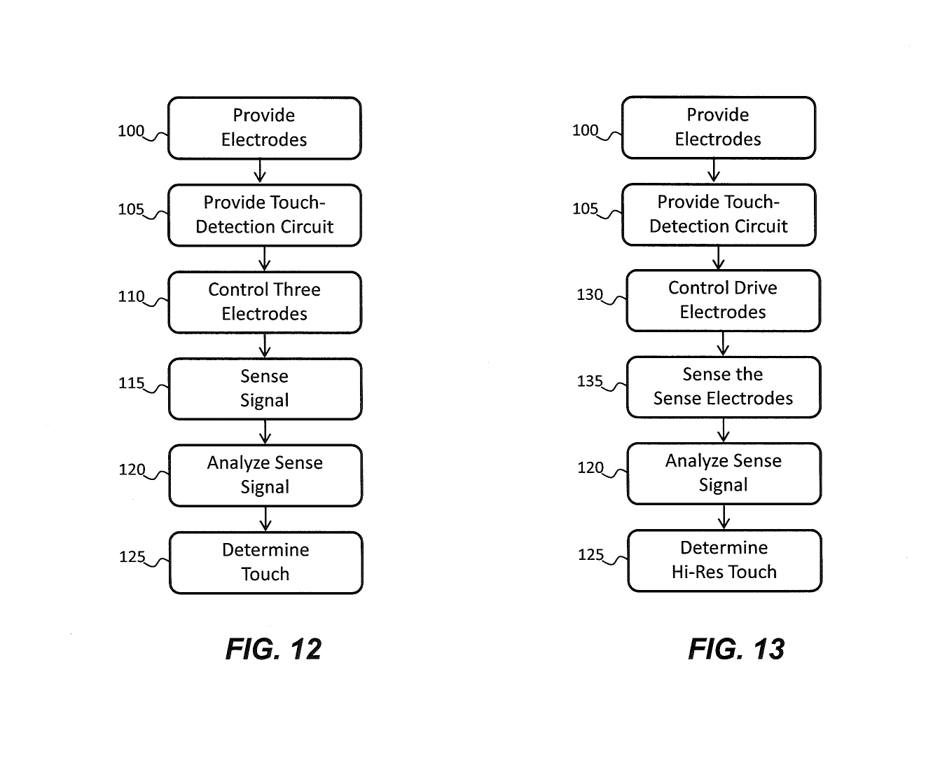

Referring to FIG. 12, in an embodiment of a method of the present invention, a plurality of electrodes 16 are provided over a surface 12 in a touch-detection area 70 in step 100. The plurality of electrodes 16 include a first array of independently controlled and electrically separate drive electrodes 30 and a second array of independently controlled and electrically separate sense electrodes 20. The first array of drive electrodes 30 and second array of sense electrodes 20 define touch locations 60 in the touch-detection area 70. A touch-detection circuit 80 having a separate connection to each of the drive electrodes 30 and a separate connection to each of the sense electrodes 20 is provided in step 105 for detecting touches at a touch location 60 in the touch-detection area 70. In step 110, the touch-detection circuit 80 is used to control three or more electrodes 16 at the same time to sense (step 115) a single sense signal 95 responsive to the controlled three or more electrodes 16. The three or more electrodes 16 include at least one drive electrode 30 and at least one sense electrode 30. A processor is used to analyze (step 120) the single sense signal 95 and determine (step 125) a touch at a touch location 60.

In a further embodiment, the touch-detection circuit 80 controls two or more drive electrodes 30 with a common drive signal at the same time and senses a single sense signal 95 with one or more sense electrodes 20 at the same time. Alternatively, the touch-detection circuit 80 controls one or more drive electrodes 30 with a common drive signal at the same time and senses a single sense signal 95 with two or more sense electrodes 20 at the same time. The touch-detection circuit 80 can sense a sense signal from each of the two or more sense electrodes 20 and combine the sense signals to form a single sense signal 95 and determine the touch. The touch-detection circuit 80 can control two or more drive electrodes 30 with a common drive signal at the same time and sense a single sense signal 95 with two or more sense electrodes 20 at the same time.

Referring to FIG. 13, in a further embodiment, electrodes 16 are provided in step 100 and a touch-detection circuit 80 provided in step 105. The touch-detection circuit 80 separately and sequentially controls one or more drive electrodes 30 with a drive signal in step 130. For each controlled one or more drive electrodes 30, the touch-detection circuit 80 separately senses a single sense signal 95 for one or more sense electrodes 20 in step 135. The processor 90 analyzes the single sense signals 95 in step 120 and determines a touch in step 125, thereby performing a high-resolution scan of the touch-detection area 70 to determine a high-resolution touch at a touch location 60 within a high-resolution touch-detection area 70 defined by the controlled one or more drive electrodes 30 and sensed one or more sense electrodes 20.

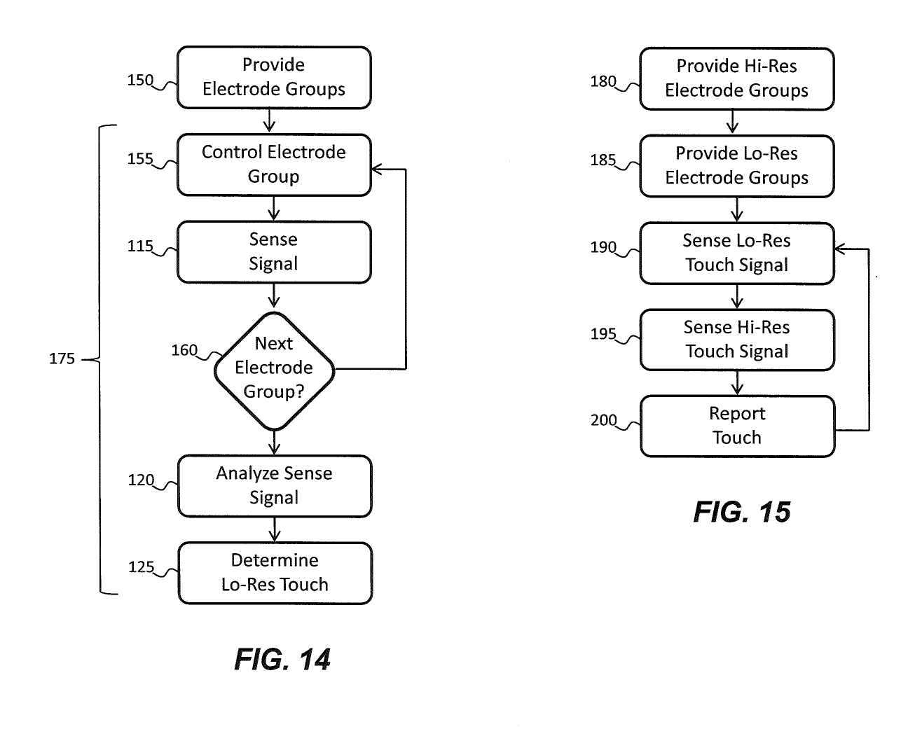

In a further embodiment of the present invention for example as illustrated in FIG. 14, electrodes 16 are associated into groups in step 150, at least one electrode group having three or more electrodes 16 including at least one drive electrode 30 and at least one sense electrode 20. The touch-detection circuit 80 separately and sequentially controls one or more electrode groups in step 155, wherein controlling each electrode group includes controlling the three or more electrodes 16 in the electrode group at the same time to sense a single sense signal 95 responsive to the controlled three or more electrodes 16 in step 115. If all of the electrode groups have been tested, the processor 90 analyzes in step 120 the single sense signal 95 of each controlled one or more electrode groups to determine a touch in step 125, thereby performing a low-resolution scan of at least a portion of the touch-detection area 70 to determine a low-resolution touch at a touch location 60 within a low-resolution touch area defined by the controlled drive electrodes 30 and sensed sense electrodes 20. If not all of the electrode groups have been tested (step 160), the next electrode group is controlled in step 155. Steps 155 to 125 taken together sense a touch signal (step 175).

Referring to FIG. 15, the present invention also includes defining a first set of electrode groups including a first number of drive and sense electrodes 30, 20 in step 180 and defining a second set of electrode groups including a second number of drive and sense electrodes 30, 20 that is less than the first number in step 185. The first set of electrodes 16 can define a low-resolution set and the second set of electrodes 16 can define a high-resolution set. The touch-detection circuit 80 separately and sequentially controls the electrodes 16 in the first set of electrode groups to sense a corresponding first set of first single sense signals 95 and the processor 90 analyzes the first single sense signals 95 to determine a first touch at a first touch location 60 in step 190. This process includes step 175 (FIG. 14). The touch-detection circuit 80 separately and sequentially controls the electrodes 16 in the second set of electrode groups to sense a corresponding second set of second single sense signals 95 and the processor 90 analyzes the second single sense signals 95 to determine a second touch at a second touch location 60 to determine a second touch at a second touch location 60 in step 195. This process includes step 175 (FIG. 14). The first and second touch locations can, and generally are, the same touch location 60. The touch is then reported (step 200).

In an embodiment, the second set of electrode groups is defined to include the drive and sense electrodes 30, 20 defining the first touch location 60 and to include fewer than all of the drive electrodes 30 or fewer than all of the sense electrodes 20. Thus, a first set of electrode groups includes more electrodes 16 than a second set of electrode groups. Furthermore, the low-resolution area defined by the first set of electrode groups can include the low-resolution area defined by the second set of electrode groups. Thus, by progressively scanning smaller and smaller subsets of areas at increasingly higher resolution, a touch is located at a particular touch location 60, as illustrated in FIGS. 10A-10D. Therefore, according to a further embodiment, the touch-detection circuit 80 separately and sequentially controls one or more drive electrodes 30 with a drive signal and, for each controlled drive electrode 30, the touch-detection circuit 80 separately senses a single sense signal 95 for one or more sense electrodes 20. The processor 90 analyzes the single sense signals 95 and determines a touch, thereby performing a high-resolution scan of an area to determine a high-resolution touch at a touch location 60 within a high-resolution touch area defined by the controlled one or more drive electrodes 30 and sensed one or more sense electrodes 20.

In various embodiments, the high-resolution touch is located within the low-resolution touch area. Moreover, in an embodiment, a low-resolution scan is repeatedly alternated with a high-resolution scan.

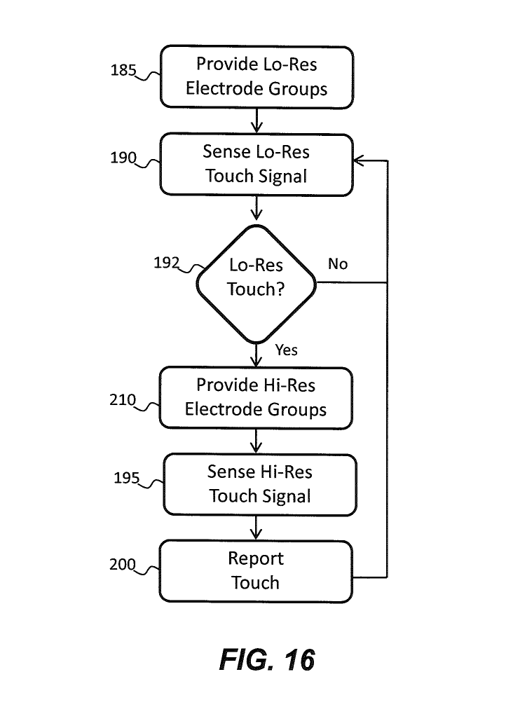

Referring to FIG. 16, in another embodiment, low-resolution electrode groups are provided in step 185 and tested in step 190. If a touch is not detected in step 192, the low-resolution test is repeated (step 190). If a touch is detected in step 192, a high-resolution electrode group is provided in step 210, tested in step 195, and reported in step 200, after which the low-resolution test is repeated (step 190). Thus, a low-resolution scan is repeated until a low-resolution touch is determined and then a high-resolution scan performed and a touch reported (step 200).

The high-resolution electrode group can be provided (step 210) in response to the location of the touch determined by the low-resolution test step 190 and can use only a portion of the drive electrodes 30 or only a portion of the sense electrodes 20, or only a portion of each of the drive electrodes 30 or sense electrodes 20.

In an embodiment, the low-resolution scan is done faster than the high-resolution scan or the low-resolution scan is done using less energy than the high-resolution scan. Since fewer low-resolution scans are needed to test the possible touch locations 60, the scans can be done faster than the high-resolution scans. Alternatively or in addition, since fewer scans are done, less energy is used.

Elements of the present invention can be provided from sources known in the display, touch screen, and integrated circuit manufacturing arts.

Substrates 10 can be a transparent dielectric layer or include transparent dielectric layers with opposing, substantially parallel sides made of, for example, glass or polymers and are known in the art. Such transparent dielectric substrates can be, for example, 10 microns-1 mm thick, or more, for example 1-5 mm thick; the present invention is not limited to any particular substrate thickness. The sense and drive electrodes 20, 30 are, for example, formed on opposing sides of transparent dielectric substrate using photolithographic methods known in the art, for example sputtering, patterned coating, or unpatterned coating followed by coating with photosensitive material that is subsequently patterned with light, patterned removal, and etching.

Electrodes can be formed from transparent conductive materials such as transparent conductive oxides or spaced-apart micro-wires including metal. In an embodiment, transparent dielectric layer substrate is substantially transparent, for example having a transparency of greater than 90%, 80%, 70%, or 50% in the visible range of electromagnetic radiation. In a further embodiment of the present invention, substrate 10 is flexible.

Sense and drive electrodes 20, 30 can include, for example, materials such as transparent conductive oxides, thin metal layers, or patterned metal micro-wires. Micro-wires can include cured or sintered metal particles such as nickel, tungsten, silver, gold, titanium, or tin or alloys such as nickel, tungsten, silver, gold, titanium, or tin. Materials, deposition, and patterning methods for forming electrodes on dielectric substrates are known in the art and can be employed in concert with the present invention. The physical arrangement or materials of drive and sense electrodes 30, 20 do not limit the present invention. Furthermore, the terms “drive” and “sense” electrodes are used for clarity in exposition and other terms or methods for controlling electrodes for sensing capacitance over a touch-detection area 70 are included herein.

Sense-electrode direction 22 of sense electrodes 20 or drive-electrode direction 32 of drive electrodes 30 is typically the direction of the greatest spatial extent of corresponding sense or drive electrode 20, 30 over, on, or under a side of substrate 10. Electrodes formed on or over substrates 10 are typically rectangular in shape, or formed of rectangular elements, with a length and a width, and the length is much greater than the width. See, for example, the prior-art illustrations of FIG. 17. In any case, the sense-electrode direction 22 or the drive-electrode direction 32 can be selected to be a direction of desired greatest extent of the sense or drive electrode 20, 30 respectively. Electrodes 16 are generally used to conduct electricity from a first point on the substrate 10 to a second point and the direction of the electrode 16 from the first point to the second point can be the length direction.

Touch-detection circuit 80 can be a digital or analog controller, for example a touch-screen controller, can include a processor, logic circuits, programmable logic arrays, one or more integrated or discrete circuits on one or more printed circuit boards, or other computational and control elements providing circuits or a memory and can include software programs or firmware. The electrical signals are, for example, electronic analog or digital signals. Signals, for example sensed capacitive signals, can be measured as analog values and converted to digital values. Signals can be, for example, capacitive, current, or voltage values. Such control, storage, computational, signaling devices, circuits, and memories are known in the art and can be employed with the present invention.

Capacitors are formed by adjacent drive and sense electrodes 30, 20 at touch locations 60 and store charge when energized, for example by providing a voltage differential across the drive and sense electrodes 30, 20. The charge for each capacitor can be measured using sense circuits 92 in touch-detection circuit 80 and the measured capacitance value stored in a memory. By repeatedly providing a voltage differential across the drive and sense electrodes 30, 20 and measuring the differential, the capacitances at touch locations 60 are repeatedly measured over time. Time-base circuits, such as clocks 83, are well known in the computing arts and can be employed. For example, a clock signal, as well as other control signals, is supplied to touch-detection circuit 80 and processor 90.

Methods and device for forming and providing substrates 10, including coating substrates, patterning coated substrates, or pattern-wise depositing materials on a substrate are known in the photo-lithographic arts. Likewise, tools for laying out electrodes, conductive traces, and connectors are known in the electronics industry as are methods for manufacturing such electronic system elements. Hardware controllers for controlling touch screens and displays and software for managing display and touch screen systems are well known and can be employed with the present invention. Tools and methods of the prior art can be usefully employed to design, implement, construct, and operate the present invention. Methods, tools, and devices for operating capacitive touch screens can be used with the present invention.

A touch-screen device of the present invention can be usefully employed with display devices of the prior art. Such devices can include, for example, OLED displays and lighting, LCD displays, plasma displays, inorganic LED displays and lighting, electrophoretic displays, electrowetting displays, dimming mirrors, smart windows, transparent radio antennae, transparent heaters and other touch screen devices such as resistive touch screen devices.

The invention has been described in detail with particular reference to certain embodiments thereof, but it will be understood that variations and modifications can be effected within the spirit and scope of the invention.

### PARTS LIST

5 capacitive touch-screen device
10 substrate
12 surface
16 electrodes
20 sense electrode
22 sense-electrode direction
30 drive electrode
32 drive-electrode direction
40 touch-screen controller
42 sense-electrode circuit
44 drive-electrode circuit
46 control circuit
50 wire
52 via
60 touch location
70 touch-detection area
80 touch-detection circuit
81 drive-signal circuit
82 counter
83 clock
84 memory
85 analog switch
85A drive-signal analog switch
85B sense-signal analog switch
86 analog-switch input
87 analog-switch output
88 analog-switch control
89 analog-switch element
91 processor
92 sense circuit
93 sense-combining circuit
94 drive-control circuit
95 single sense signal
96 sense-control circuit
100 provide electrodes step
105 provide touch detection circuit step
110 control three electrodes step
115 sense signal step
120 analyze sense signal step
125 determine touch step
130 control drive electrodes step
135 sense the sense electrodes step
150 provide electrode groups step
155 control electrode group step
160 next electrode group decision step
175 sense touch signal
180 provide hi-res electrode groups step
185 provide lo-res electrode groups step
190 sense lo-res touch signal step
192 lo-res touch detected decision step
195 sense hi-res touch signal step
200 report touch step
210 provide hi-res electrode groups responsive to lo-res touch signal step

1. A method for touch sensing in a touch-screen device, comprising:
providing an array of independently controlled and electrically separate drive electrodes, an array of independently controlled and electrically separate sense electrodes, wherein the drive electrodes and the sense electrodes define touch locations in a touch-detection area;
providing a touch-detection circuit having a separate connection to each of the drive electrodes and a separate connection to each of the sense electrodes for detecting touches at a touch location in the touch-detection area;
using the touch-detection circuit to control three or more electrodes at the same time to detect a single sense signal responsive to the controlled three or more electrodes, the three or more electrodes including at least one drive electrode and at least one sense electrode; and
using a processor to analyze the single sense signal and determine a touch at a touch location.

2. The method of claim 1, further including using the touch-detection circuit to control two or more drive electrodes with a common drive signal at the same time and detect a single sense signal with one or more sense electrodes at the same time.

3. The method of claim 2, wherein the two or more drive electrodes are adjacent.

4. The method of claim 2, wherein the two or more drive electrodes are not adjacent.

5. The method of claim 1, further including using the touch-detection circuit to control one or more drive electrodes with a common drive signal at the same time and detect a single sense signal with two or more sense electrodes at the same time.

6. The method of claim 5, wherein the two or more sense electrodes are adjacent.

7. The method of claim 5, wherein the two or more sense electrodes are not adjacent.

8. The method of claim 5, further including using the touch-detection circuit to detect a sense signal from each of the two or more sense electrodes and combine the sense signals to form a single sense signal and determine the touch.

9. The method of claim 1, further including using the touch-detection circuit to control two or more drive electrodes with a common drive signal at the same time and detect a single sense signal with two or more sense electrodes at the same time.

10. The method of claim 1, further including:
using the touch-detection circuit to separately and sequentially control one or more drive electrodes with a drive signal;
for each controlled one or more drive electrodes, using the touch-detection circuit to separately detect a single sense signal for one or more sense electrodes; and
using the processor to analyze the single sense signals and determine a touch, thereby performing a high-resolution scan of the touch-detection area to determine a high-resolution touch at a touch location within a high-resolution touch area defined by the controlled one or more drive electrodes and sensed one or more sense electrodes.

11. The method of claim 1, further including:
associating the electrodes into groups, at least one electrode group having three or more electrodes including at least one drive electrode and at least one sense electrode;
using the touch-detection circuit to separately and sequentially control one or more electrode groups, wherein controlling each electrode group includes controlling the three or more electrodes in the electrode group at the same time to detect a single sense signal responsive to the controlled three or more electrodes; and
using the processor to analyze the single sense signal of each controlled one or more electrode groups to determine a touch, thereby performing a low-resolution scan of at least a portion of the touch-detection area to determine a low-resolution touch at a touch location within a low-resolution touch area defined by the controlled drive electrodes and sensed sense electrodes.

12. The method of claim 11, wherein no sense electrode is included in more than one electrode group or wherein no drive electrode is included in more than one electrode group.

13. The method of claim 11, wherein at least one sense electrode is included in more than one group or wherein at least one drive electrode is included in more than one group.

14. The method of claim 11, wherein the electrode groups include all of the sense electrodes and all of the drive electrodes.

15. The method of claim 11, wherein the electrode groups include fewer than all of the sense electrodes or fewer than all of the drive electrodes.

16. The method of claim 11, further including:
defining a first set of electrode groups including a first number of drive and sense electrodes;
defining a second set of electrode groups including a second number of drive and sense electrodes that is less than the first number;
using the touch-detection circuit to separately and sequentially control the electrodes in the first set of electrode groups to detect a corresponding first set of first single sense signals and using the processor to analyze the first single sense signals to determine a first touch at a first touch location; and
using the touch-detection circuit to separately and sequentially control the electrodes in the second set of electrode groups to detect a corresponding second set of second single sense signals and using the processor to analyze the second single sense signals to determine a second touch at a second touch location.

17. The method of claim 16, further including defining the second set of electrode groups to include the drive and sense electrodes defining the first touch location and to include fewer than all of the drive electrodes or fewer than all of the sense electrodes.

18. The method of claim 16, wherein the low-resolution area defined by the first set of electrode groups includes the low-resolution area defined by the second set of electrode groups.

19. The method of claim 11, further including:
using the touch-detection circuit to separately and sequentially control one or more drive electrodes with a drive signal;
for each controlled drive electrode, using the touch-detection circuit to separately detect a single sense signal for one or more sense electrodes; and
using the processor to analyze the single sense signals and determine a touch, thereby performing a high-resolution scan of an area to determine a high-resolution touch at a touch location within a high-resolution touch area defined by the controlled one or more drive electrodes and sensed one or more sense electrodes.

20. The method of claim 19, wherein the high-resolution touch is located within the low-resolution touch area.

21. The method of claim 19, further including repeatedly alternating a low-resolution scan with a high-resolution scan.

22. The method of claim 19, further including repeating a low-resolution scan until a low-resolution touch is determined and then performing a high-resolution scan.

23. The method of claim 19, further including performing a high-resolution scan using only a portion of the drive electrodes or only a portion of the sense electrodes.

24. The method of claim 19, wherein the low-resolution scan is done faster than the high-resolution scan or wherein the low-resolution scan is done using less energy than the high-resolution scan.
